(19) United States
(12) Patent Application Publication
(10) Pub. No.: US 2013/0010360 A1
(43) Pub. Date: Jan. 10, 2013

(54) COMPACT OPTICAL INTEGRATOR

(76) Inventors: Andrew J. Ouderkirk, Saint Paul, MN (US); Zhisheng Yun, Woodbury, MN (US); Kim L. Tan, Singapore (SG)

(21) Appl. No.: 13/520,190

(22) PCT Filed: Jan. 3, 2011
(86) PCT No.: PCT/US11/20025

§ 371 Date: Jul. 2, 2012

Related U.S. Application Data
(60) Provisional application No. 61/292,574, filed on Jan. 6, 2010.

(51) Int. Cl. G02B 27/10; G02B 27/28

(52) U.S. Cl. 359/485.07; 359/485.01

(57) ABSTRACT

Generally, the present disclosure describes a compact optical integrator that provides an increased path length for a beam of light in a compact projection system. The increased path length can improve the uniformity of the light passing through the compact projection system, with a minimal increase in the size of the system. The light can be homogenized by mixing light entering the integrator from different regions of the input area. The compact optical integrator can be positioned in the optical path between a light source and a spatial light modulator, such as a liquid crystal display (LCD) or a digital micro-mirror (DMM) array.

### BACKGROUND

Projection systems used for projecting an image on a screen can use multiple color light sources, such as light emitting diodes (LED's), with different colors to generate the illumination light. Several optical elements are disposed between the LED's and the image display unit to combine and transfer the light from the LED's to the image display unit. The image display unit can use various methods to impose an image on the light. For example, the image display unit may use polarization, as with transmissive or reflective liquid crystal displays.

Still other projection systems used for projecting an image on a screen can use white light configured to imagewise reflect from a digital micro-mirror (DMM) array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

Image brightness is an important parameter of a projection system. The brightness of color light sources and the efficiencies of collecting, combining, homogenizing and delivering the light to the image display unit all affect brightness. As the size of modern projector systems decreases, there is a need to maintain an adequate level of output brightness while at the same time keeping heat produced by the color light sources at a low level that can be dissipated in a small projector system. There is a need for a light combining system that combines multiple color lights with increased efficiency to provide a light output with an adequate level of brightness without excessive power consumption by light sources.

Such electronic projectors often include a device for optically homogenizing a beam of light in order to improve brightness and color uniformity for light projected on a screen. Two common devices are an integrating tunnel and a fly's eye homogenizer.

Fly's eye homogenizers can be very compact, and for this reason is a commonly used device. Integrating tunnels can be more efficient at homogenization, but a hollow tunnel generally requires a length that is often 5 times the height or width, whichever is greater. Solid tunnels often are longer than hollow tunnels, due to the effects of refraction.

Pico and pocket projectors have limited available space for light integrators or homogenizers. However, efficient and uniform light output from the optical devices used in these projectors (such as color combiners and polarization converters) can require a compact and efficient integrator.

### SUMMARY

Generally, the present description relates to optical integrators that can be used to improve the uniformity of an input light beam. In one aspect, the present disclosure provides an optical integrator that includes a polarizing beam splitter (PBS), having an input surface disposed to receive an input light beam normal to the input surface, an output surface, and a first and a second side surface. The optical integrator further includes a reflective polarizer aligned to a first polarization direction and disposed within the PBS to intercept the input light beam at an angle of approximately 45 degrees. The optical integrator still further includes a first polarization rotating reflector disposed facing the first side surface, wherein the reflective polarizer and the polarization rotating reflector cooperate so that a path length of the input light beam from the input surface to the output surface within the optical integrator is at least about two times a length of the PBS measured normal to the input surface.

In another aspect, the present disclosure provides an optical integrator that includes a polarizing beam splitter (PBS) having a first surface disposed to receive an input light beam normal to the first surface, a first side surface, a second side surface, and a third side surface. The optical integrator further includes a reflective polarizer aligned to a first polarization direction and disposed within the PBS to intercept the input light beam at an angle of approximately 45 degrees. The optical integrator still further includes a first, a second, and a third polarization rotating reflector disposed facing the second, third and fourth side surfaces, respectively, wherein the reflective polarizer and the polarization rotating reflectors cooperate so that a path length of the input light beam from the first surface, through the optical integrator, and returning to the first surface is at least about four times a length of the PBS measured normal to the first surface.

In yet another aspect, the present disclosure provides an optical integrator that includes a first polarizing beam splitter (PBS) having a first input surface disposed to receive an input light beam normal to the input surface, a first output surface adjacent the first input surface, a second output surface opposite the first input surface, and a first side surface. The first PBS further includes a first reflective polarizer aligned to a first polarization direction and disposed within the first PBS to intercept the input light beam at an angle of approximately 45 degrees, and a first polarization rotating reflector disposed facing the first side surface. The optical integrator further includes a second PBS having a second input surface disposed facing the first output surface and capable of receiving a first output light beam from the first PBS. The second PBS further includes three side surfaces, a second reflective polarizer aligned to the first polarization direction and disposed within the second PBS to intercept the first output light beam at an angle of approximately 45 degrees, and a second, a third, and a fourth polarization rotating reflector disposed facing each of the three side surfaces, wherein the reflective polarizers and the polarization rotating reflectors cooperate so that a path length of the input light beam from the first input surface to the second output surface within the optical integrator is at least about seven times a length of the first PBS measured normal to the input surface.

In yet another aspect, the present disclosure provides an optical integrator that includes a first and a second polarizing beam splitter (PBS), each PBS having an input surface disposed to receive an input light beam normal to the input surface, an output surface adjacent the input surface, and two side surfaces. Each PBS further includes a reflective polarizer aligned to a first polarization direction and disposed within the PBS to intercept the input light beam at an angle of approximately 45 degrees. The optical integrator further includes and a first and a second polarization rotating reflector disposed facing each of the two side surfaces, wherein the output surface of the first PBS faces the input surface of the second PBS, and further wherein the reflective polarizers and the polarization rotating reflectors cooperate so that a path length of the input light beam from the input surface of the first PBS to the output surface of the second PBS within the optical integrator is at least about six times a length of the first PBS measured normal to the input surface.

In yet another aspect, the present disclosure provides an optical integrator that includes a polarizing beam splitter (PBS) having an input surface disposed to receive an input light beam normal to the input surface, an output surface adjacent the input surface, and two side surfaces. The PBS further includes a reflective polarizer aligned to a first polarization direction and disposed within the PBS to intercept the input light beam at an angle of approximately 45 degrees, and a retarder disposed immediately adjacent the reflective polarizer and opposite the input surface, the retarder aligned at an angle of approximately 45 degrees to the first polarization direction. The optical integrator further includes a first and a second broadband mirror disposed facing each of the two side surfaces, wherein the reflective polarizer, the retarder, and the broadband mirrors cooperate so that a path length of the input light beam from the input surface to the output surface within the optical integrator is at least about three times a length of the PBS measured normal to the input surface.

In yet another aspect, the present disclosure provides an optical integrator that includes a polarizing beam splitter (PBS) having a first surface disposed to receive an input light beam normal to the first surface, a second surface adjacent the first surface, and two side surfaces. The PBS further includes a reflective polarizer aligned to a first polarization direction and disposed within the PBS to intercept the input light beam at an angle of approximately 45 degrees and a retarder disposed immediately adjacent the reflective polarizer and opposite the input surface, the retarder aligned at an angle of approximately 45 degrees to the first polarization direction. The optical integrator still further includes a first and a second broadband mirror disposed facing each of the two side surfaces, and a polarization rotating reflector disposed facing the second surface, wherein the reflective polarizer, the retarder, the polarization rotating reflector, and the broadband mirrors cooperate so that a path length of the input light beam from the input surface to the output surface within the optical integrator is at least about three times a length of the PBS measured normal to the input surface.

In yet another aspect, the present disclosure provides an optical integrator that includes a first polarizing beam splitter (PBS) having a first input surface disposed to receive an input light beam normal to the input surface, a first output surface adjacent the first input surface, a second output surface opposite the first input surface, and a first side surface. The first PBS further includes a first reflective polarizer aligned to a first polarization direction and disposed within the first PBS to intercept the input light beam at an angle of approximately 45 degrees, and a first polarization rotating reflector disposed facing the first side surface. The optical integrator further includes a second PBS having a second input surface disposed facing the first output surface and capable of receiving a first output light beam from the first PBS, a first, a second, and a third side surfaces; a second reflective polarizer aligned to the first polarization direction and disposed within the second PBS to intercept the first output light beam at an angle of approximately 45 degrees; and a retarder disposed immediately adjacent the second reflective polarizer, opposite the second input surface. The optical integrator still further includes a first and a second broadband mirror disposed facing the first and the second side surfaces, respectively, adjacent the retarder; and a second polarization rotating reflector disposed facing the third side surface, wherein the reflective polarizers, the polarization rotating reflectors, the retarder, and the broadband mirrors cooperate so that a path length of the input light beam from the first input surface to the second output surface within the optical integrator is at least about seven times a length of the first PBS measured normal to the input surface.

In yet another aspect, the present disclosure provides an optical integrator that includes a first and a second polarizing beam splitter (PBS), each PBS having an input surface disposed to receive an input light beam normal to the input surface, an output surface adjacent the input surface, and two side surfaces. Each PBS further includes a reflective polarizer aligned to a first polarization direction and disposed within the PBS to intercept the input light beam at an angle of approximately 45 degrees, and a retarder disposed immediately adjacent the reflective polarizer and opposite the input surface, the retarder aligned at an angle of approximately 45 degrees to the first polarization direction. The optical integrator further includes a first and a second broadband mirror disposed facing each of the two side surfaces, wherein the output surface of the first PBS is facing the input surface of the second PBS, and further wherein the reflective polarizers, the retarders, and the broadband mirrors cooperate so that a path length of the input light beam from the input surface to the output surface within the optical integrator is at least about six times a length of the PBS measured normal to the input surface.

In yet another aspect, the present disclosure provides an optical integrator that includes a first and a second polarizing beam splitter (PBS), each PBS having an input surface disposed to receive an input light beam normal to the input surface, a first output surface, a second output surface opposite the input surface, and a side surface. Each PBS further includes a reflective polarizer aligned to a first polarization direction and disposed within the PBS to intercept the input light beam at an angle of approximately 45 degrees, and a first polarization rotating reflector disposed facing the side surface, wherein the first output surface of the first PBS faces the first output surface of the second PBS. The optical integrator further includes a half-wave retarder disposed between the first output surface of the first PBS and the first output surface of the second PBS, wherein the reflective polarizers, the polarization rotating reflectors, and the half-wave retarder cooperate so that a path length of the input light beam from the input surface of the first PBS to the second output surface of the second PBS within the optical integrator is at least about three times a length of the first PBS measured normal to the input surface.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1 is a perspective view of a polarizing beam splitter (PBS);

FIG. 2 is a perspective view of the alignment of a quarter-wave retarder to a PBS;

FIG. 3 is a top view of a path of light rays within a PBS;

FIG. 4 is a perspective view of a PBS;

FIG. 5 is a cross-sectional schematic of a light path;

FIGS. 6A-6C are cross-sectional schematic views of an optical integrator;

FIG. 7 is a cross-sectional schematic view of an optical integrator;

FIG. 8 is a cross-sectional schematic view of an optical integrator;

FIG. 9 is a cross-sectional schematic view of an optical integrator;

FIG. 10 is a cross-sectional schematic view of an optical integrator;

FIG. 11 is a cross-sectional schematic view of an optical integrator; and

FIG. 12 is a cross-sectional schematic view of an optical integrator.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure describes a compact optical integrator that provides an increased path length for a beam of light in a compact projection system. The increased path length can improve the uniformity of the light passing through the compact projection system, with a minimal increase in the size of the system. In some cases, the light is homogenized by mixing light entering the integrator from different regions of the input area. In one aspect, the compact optical integrator is positioned in the optical path between a light source and a spatial light modulator, such as an LCD or a DMM array. Generally, the compact optical integrator includes a polarizing beam splitter (PBS), where the PBS has an input face, at least one face that reflects light and rotates the polarization 90 degrees, and a exit face that is either the same as the entry face, or a different face. The optical path length of the light beam entering the compact optical integrator can increase several times the dimensions of the PBS, depending on the design, as described herein. The compact optical integrator can also serve to divert a beam of light, and also to rotate the polarization state of a beam of light.

The optical elements described herein can be configured as compact optical integrators that receive different wavelength spectrum light inputs or a combined light input that includes the different wavelength spectrum lights, and output a homogenized light output. The input light to the optical integrator can be the output of a color combiner such as those described, for example, in PCT Patent Publication Nos. WO2009/085856 entitled “Light Combiner”, WO2009/086310 entitled “Light Combiner”, WO2009/139798 entitled “Optical Element and Color Combiner”, WO2009/139799 entitled “Optical Element and Color Combiner”; and also in co-pending PCT Patent Application Nos. US2009/062939 entitled “Polarization Converting Color Combiner”, US2009/063779 entitled “High Durability Color Combiner”, US2009/064927 entitled “Color Combiner”, and US2009/064931 entitled “Polarization Converting Color Combiner”.

In one aspect, the received light inputs are unpolarized, and the homogenized light output is also unpolarized. In one aspect, the received light inputs are polarized, and the homogenized light output is also polarized. In one embodiment, the homogenized light output is polarized in the same polarization direction as the received input lights. In another embodiment, the homogenized light output is polarized in the orthogonal polarization direction as the received input light. In one aspect, the light output can be a single color light, a single color component of light, a single polarization component of light, or a mixture of colors and polarizations.

The homogenized light output can be a polychromatic combined light that comprises more than one wavelength spectrum of light. The homogenized light output can be a time sequenced output of each of the received lights. In one aspect, each of the different wavelength spectra of light corresponds to a different color light (for example red, green and blue), and the homogenized light output is white light, or a time sequenced red, green and blue light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

Also for the purposes of the description provided herein, the term “aligned to a desired polarization state” is intended to associate the alignment of the pass axis of an optical element to a desired polarization state of light that passes through the optical element, that is, a desired polarization state such as s-polarization, p-polarization, right-circular polarization, left-circular polarization, or the like. In one embodiment described herein with reference to the Figures, an optical element such as a polarizer aligned to the first polarization state means the orientation of the polarizer that passes the p-polarization state of light, and reflects or absorbs the second polarization state (in this case the s-polarization state) of light. It is to be understood that the polarizer can instead be aligned to pass the s-polarization state of light, and reflect or absorb the p-polarization state of light, if desired.

Also for the purposes of the description provided herein, the term “facing” refers to one element disposed so that a perpendicular line from the surface of the element follows an optical path that is also perpendicular to the other element. One element facing another element can include the elements disposed adjacent each other. One element facing another element further includes the elements separated by optics so that a light ray perpendicular to one element is also perpendicular to the other element.

According to one aspect, the optical integrator comprises a reflective polarizer positioned so that the received light intercepts the reflective polarizer at approximately a 45 degree angle. The reflective polarizer can be any known reflective polarizer such as a MacNeille polarizer, a wire grid polarizer, a multilayer optical film polarizer, or a circular polarizer such as a cholesteric liquid crystal polarizer. According to one embodiment, a multilayer optical film polarizer, for example, a polymeric multilayer optical film polarizer, can be a preferred reflective polarizer.

Multilayer optical film polarizers can include different “packets” of layers that serve to interact with different wavelength ranges of light. For example, a unitary multilayer optical film polarizer can include several packets of layers through the film thickness, each packet interacting with a different wavelength range (for example color) of light to reflect one polarization state and transmit the other polarization state. In one aspect, a multilayer optical film can have a first packet of layers adjacent a first surface of the film that interacts with, for example, blue colored light (that is, a “blue layers”), a second packet of layers that interacts with, for example, green colored light (that is, a “green layers”), and a third packet of layers adjacent a second surface of the film that interacts with, for example, red colored light (that is a “red layers”). Typically, the separation between layers in the “blue layers” is much smaller than the separation between layers in the “red layers”, in order to interact with the shorter (and higher energy) blue wavelengths of light.

Polymeric multilayer optical film polarizers can be particularly preferred reflective polarizers that can include packets of film layers as described above. Often, the higher energy wavelengths of light, such as blue light, can adversely affect the aging stability of the film, and at least for this reason it is preferable to minimize the number of interactions of blue light with the reflective polarizer. In addition, the nature of the interaction of blue light with the film can affect the severity of the adverse aging. Transmission of blue light through the film is generally less detrimental to the film than reflection of blue light entering from the “blue layers” (that is thin layers) side. Also, reflection of blue light entering the film from the “blue layers” side is less detrimental to the film than reflection of blue light entering from the “red layers” (that is, thick layers) side.

The reflective polarizer can be disposed between the diagonal faces of two prisms, or it can be a free-standing film such as a pellicle. In some embodiments, the optical element light utilization efficiency is improved when the reflective polarizer is disposed between two prisms, for example a polarizing beam splitter (PBS). In this embodiment, some of the light traveling through the PBS that would otherwise be lost from the optical path can undergo Total Internal Reflection (TIR) from the prism faces and rejoin the optical path. For at least this reason, the following description is directed to optical elements where reflective polarizers are disposed between the diagonal faces of two prisms; however, it is to be understood that the PBS can function in the same manner when used as a pellicle. In one aspect, all of the external faces of the PBS prisms are highly polished so that light entering the PBS undergoes TIR. In this manner, light is contained within the PBS and the light is partially homogenized.

In one aspect, input light of a first polarization state is converted to a second polarization state by being directed toward a retarder and a reflector, such as a broadband mirror, where it reflects and changes polarization state by passing through the retarder twice. Light having an undesired polarization state is converted to a desired polarization state by passing through a retarder twice, before and after reflection from a reflector, changing to the desired polarization state.

In one embodiment, the retarder is placed between the reflector and the reflective polarizer. The particular combination of reflector, retarders, reflective polarizer, and source orientation all cooperate to enable a smaller, more compact, optical integrator that efficiently produces homogenized light of a desired polarization state. According to one aspect, the retarder is a quarter-wave retarder aligned at approximately 45 degrees to a polarization direction of the reflective polarizer. In one embodiment, the alignment can be from 30 to 60 degrees; from 40 to 50 degrees; from 43 to 47 degrees; or from 44.5 to 45.5 degrees to a polarization state of the reflective polarizer.

The input (or received) light beam includes light rays that can be collimated, convergent, or divergent when it enters the PBS. Convergent or divergent light entering the PBS can be lost through one of the faces or ends of the PBS. In one embodiment, to avoid such losses, all of the exterior faces of a prism based PBS can be polished to enable total internal reflection (TIR) within the PBS. Enabling TIR improves the utilization of light entering the PBS, so that substantially all of the light entering the PBS within a range of angles is redirected to exit the PBS through the desired face. In another embodiment, all of the exterior faces of a prism based PBS that are not entrance faces, exit faces, or otherwise faces that interact directly with the optical path of the light, can be coated with a reflector instead of relying on TIR to contain the light beams. However, polishing of exterior faces is a preferred technique of utilizing all input light in the homogenizer.

A polarization component of the input light can pass through to a polarization rotating reflector (PRR) that includes a retarder and a reflector. The PRR deflects the propagation direction of the light and alters the magnitude of the polarization components, depending of the type and orientation of the retarder disposed in the polarization rotating reflector. In one embodiment, the PRR can include a retarder and a mirror, for example, a broadband mirror such as a metal coating, a dielectric coating enhanced reflectivity metal coating, a dielectric broadband mirror, a dichroic reflector, an enhanced specular reflector (Vikuiti™ ESR film, available from 3M Company), and the like. The retarder can provide any desired retardation, such as an eighth-wave retarder, a quarter-wave retarder, and the like. In embodiments described herein, there can be an advantage to using a quarter-wave retarder and an associated broadband mirror. Linearly polarized light is changed to circularly polarized light as it passes through a quarter-wave retarder aligned at an angle of 45° to the axis of light polarization. Subsequent reflections from the reflective polarizer and quarter-wave retarder/reflectors in the optical integrator result in efficient homogenized light output from the optical integrator. In contrast, linearly polarized light is changed to a polarization state partway between s-polarization and p-polarization (either elliptical or linear) as it passes through other retarders and orientations, and can result in a lower efficiency of the integrator.

Generally, variations in retardation and orientation can result in elliptically polarized light; however, for brevity the descriptions contained herein refer to circular polarized light, which is understood to be an idealized case of elliptical polarized light. Polarization rotating reflectors generally comprise a reflector (for example, broadband mirror) and retarder. The position of the retarder and broadband mirror relative to the adjacent light source is dependent on the desired path of each of the polarization components, and are described elsewhere with reference to the Figures. In one aspect, the reflective polarizer can be a circular polarizer such as a cholesteric liquid crystal polarizer. According to this aspect, polarization rotating reflectors can comprise reflectors without any associated retarders.

The components of the optical integrator including prisms, reflective polarizers, quarter-wave retarders, mirrors, filters or other components can be bonded together by a suitable optical adhesive. In one embodiment, the optical adhesive used to bond the components together has an index of refraction less than or equal to the index of refraction of the prisms used in the optical element. An optical integrator that is fully bonded together offers advantages including alignment stability during assembly, handling and use. In some embodiments, two adjacent prisms can be bonded together using an optical adhesive. In some embodiments, a unitary optical component can incorporate the optics of the two adjacent prisms; for example, such as a single triangular prism which incorporates the optics of two adjacent triangular prisms, as described elsewhere.

The embodiments described above can be more readily understood by reference to the Figures and their accompanying description, which follows.

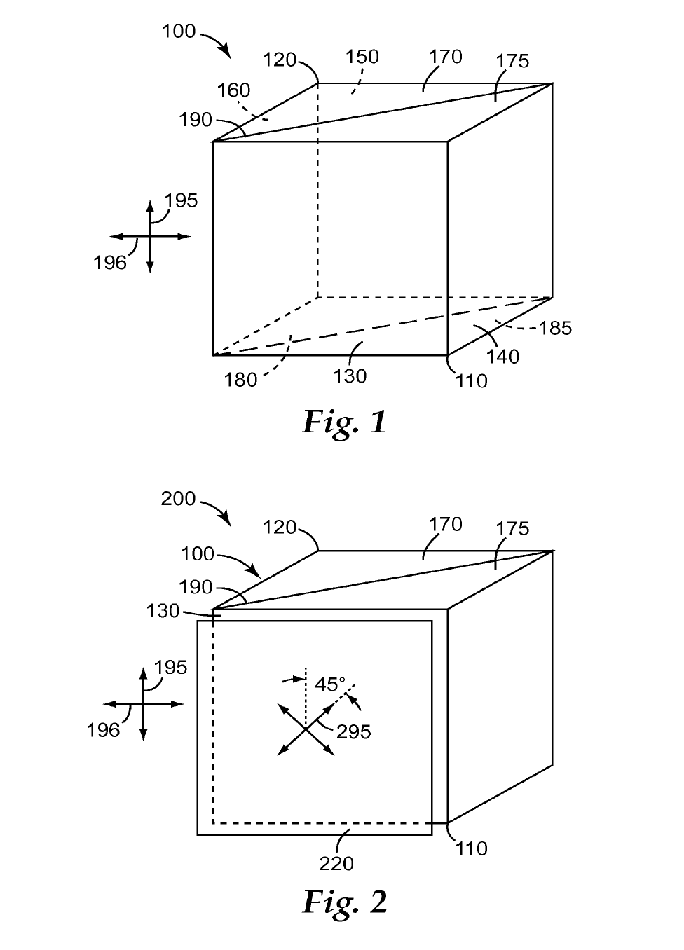

FIG. 1 is a perspective view of a PBS. PBS 100 includes a reflective polarizer 190 disposed between the diagonal faces of prisms 110 and 120. Prism 110 includes two end faces 175, 185, and a first and second prism face 130, 140 having a 90° angle between them. Prism 120 includes two end faces 170, 180, and a third and fourth prism face 150, 160 having a 90° angle between them. The first prism face 130 is parallel to the third prism face 150, and the second prism face 140 is parallel to the fourth prism face 160. The identification of the four prism faces shown in FIG. 1 with a “first”, “second”, “third” and “fourth” serves only to clarify the description of PBS 100 in the discussion that follows.

First reflective polarizer 190 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis state, and includes both wire-grid polarizers and polymeric multilayer optical films such as can be produced by extrusion and subsequent stretching of a multilayer polymeric laminate. In one embodiment, reflective polarizer 190 is aligned so that one polarization axis is parallel to a first polarization state 195, and perpendicular to a second polarization state 196. In one embodiment, the first polarization state 195 can be the s-polarization state, and the second polarization state 196 can be the p-polarization state. In another embodiment, the first polarization state 195 can be the p-polarization state, and the second polarization state 196 can be the s-polarization state. As shown in FIG. 1, the first polarization state 195 is perpendicular to each of the end faces 170, 175, 180, 185.

A Cartesian reflective polarizer film provides the polarizing beam splitter with an ability to pass input light rays that are not fully collimated, and that are divergent or skewed from a central light beam axis, with high efficiency. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

In some embodiments (not shown) at least one of the prisms 110, 120 can have an extended face that can increase the path length of a light travelling parallel to that face. For example, first prism face 130 can be extended along the second polarization direction 196, thereby moving second prism face 140 further away from reflective polarizer 190. A further example of extended-face prisms is described elsewhere, with reference to the Figures.

FIG. 2 is a perspective view of the alignment of a quarter-wave retarder to a PBS, as used in some embodiments. Quarter-wave retarders can be used to change the polarization state of incident light. PBS retarder system 200 includes PBS 100 having first and second prisms 110 and 120. A quarter-wave retarder 220 is disposed adjacent the first prism face 130. Reflective polarizer 190 is, for example, a Cartesian reflective polarizer film aligned to first polarization state 195. Quarter-wave retarder 220 includes a quarter-wave polarization state 295 that can be aligned at 45° to first polarization state 195. Although FIG. 2 shows polarization state 295 aligned at 45° to first polarization state 195 in a clockwise direction, polarization state 295 can instead be aligned at 45° to first polarization state 195 in a counterclockwise direction. In some embodiments, quarter-wave polarization state 295 can be aligned at any degree orientation to first polarization state 195, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization state. Other orientations of quarter-wave retarders can result in s-polarized light not being fully transformed to p-polarized light, and p-polarized light not being fully transformed to s-polarized light upon reflection from the mirrors, resulting in reduced efficiency of the optical elements described elsewhere in this description.

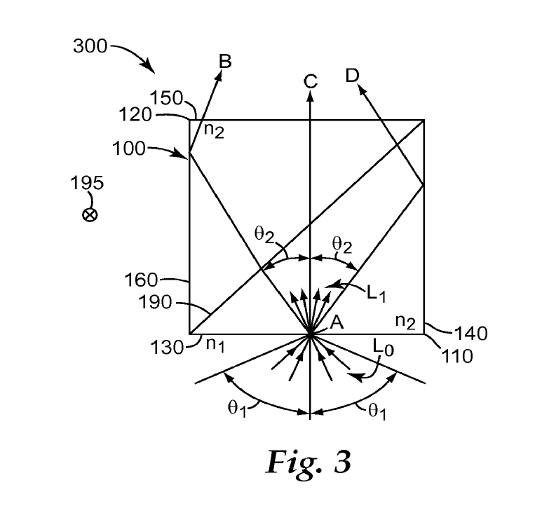

FIG. 3 shows a top view of a path of light rays within a PBS, for example, a polished PBS 300. According to one embodiment, the first, second, third and fourth prism faces 130, 140, 150, 160 of prisms 110 and 120 are polished external surfaces. According to another embodiment, all of the external faces of the PBS 100 (including end faces, not shown) are polished faces that provide TIR of oblique light rays within polished PBS 300. The polished external surfaces are in contact with a material having an index of refraction “n₁” that is less than the index of refraction “n₂” of prisms 110 and 120. TIR improves light utilization in polished PBS 300, particularly when the light directed into polished PBS 300 is not collimated along a central axis, that is the incoming light is either convergent or divergent. At least some light is trapped in polished PBS 300 by total internal reflections until it leaves through third prism face 150. In some cases, substantially all of the light is trapped in polished PBS 300 by total internal reflections until it leaves through third prism face 150.

As shown in FIG. 3, light rays L₀ enter first prism face 130 within a range of angles θ₁. Light rays L₁ within polished PBS 300 propagate within a range of angles θ₂ such that the TIR condition is satisfied at prism faces 140, 160 and the end faces (not shown). Light rays “AB”, “AC” and “AD” represent three of the many paths of light through polished PBS 300, that intersect reflective polarizer 190 at different angles of incidence before exiting through third prism face 150. Light rays “AB” and “AD” also both undergo TIR at prism faces 160 and 140, respectively, before exiting. It is to be understood that ranges of angles θ₁ and θ₂ can be a cone of angles so that reflections can also occur at the end faces of polished PBS 300. In one embodiment, reflective polarizer 190 is selected to efficiently split light of different polarizations over a wide range of angles of incidence. A polymeric multilayer optical film is particularly well suited for splitting light over a wide range of angles of incidence. Other reflective polarizers including MacNeille polarizers and wire-grid polarizers can be used, but are less efficient at splitting the polarized light. A MacNeille polarizer does not efficiently transmit light at angles of incidence that differ substantially from the design angle, which is typically 45 degrees to the polarization selective surface, or normal to the input face of the PBS. Efficient splitting of polarized light using a MacNeille polarizer can be limited to incidence angles below about 6 or 7 degrees from the normal, since significant reflection of the p-polarization state can occur at some larger angles, and significant transmission of s-polarization state can also occur at some larger angles. Both effects can reduce the splitting efficiency of a MacNeille polarizer. Efficient splitting of polarized light using a wire-grid polarizer typically requires an air gap adjacent one side of the wires, and efficiency drops when a wire-grid polarizer is immersed in a higher index medium. A wire-grid polarizer used for splitting polarized light is shown, for example, in PCT publication WO 2008/1002541.

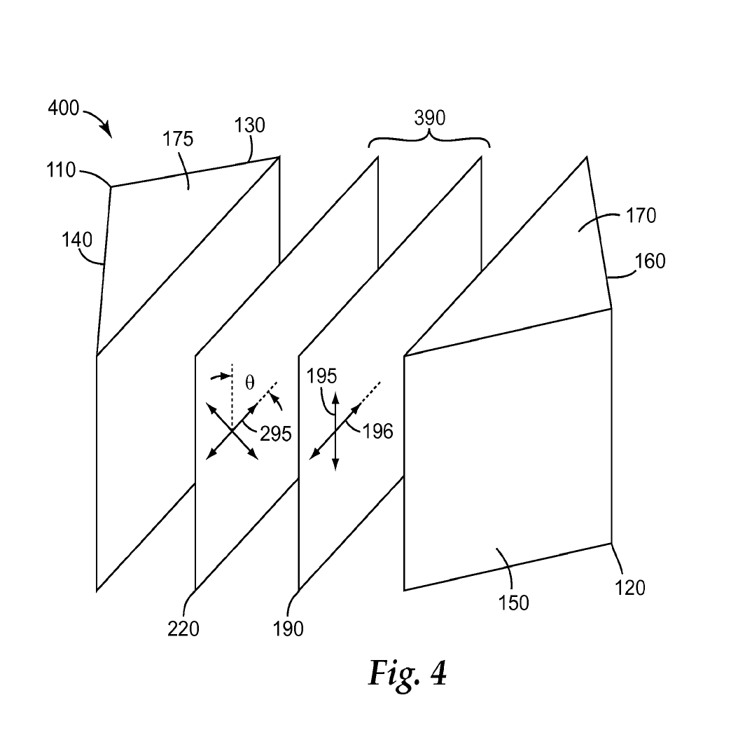

In one aspect, FIG. 4 is a perspective view of a PBS 400 that includes a first prism 110 and a second prism 120 as described elsewhere, and a reflective polarizer laminate 390 disposed on the diagonal between them. In one particular embodiment, reflective polarizer laminate 390 includes a reflective polarizer 190 disposed immediately adjacent a quarter-wave retarder 220. In some cases, for example, to reduce the number of retarders disposed on a PBS surface, it can be desired to dispose the retarder adjacent the reflective polarizer, instead of adjacent the PBS surface, as shown, for example, in FIG. 2. In this manner, a pair of retarders that arc on adjacent surfaces, for example, on the first prism face 130 and the second prism face 140 of first prism 110, can be combined into a single retarder disposed on the diagonal of the PBS 400 as shown in FIG. 4.

Reflective polarizer 190 can be aligned to a first polarization direction 195, and the quarter-wave retarder 220 can be aligned at an angle “θ” to the first polarization direction 195. In one particular embodiment, the quarter-wave retarder can be aligned at an angle θ=+/−45 degrees to the first polarization direction 195, as described elsewhere. In some cases, the retarder film (typically a quarter-wave plate, or QWP) retardation and orientation relative to the reflective polarizer slow-axis (polarization direction) can be varied to account for the 45 degree immersed incidence in glass. Optimal QWP parameters can be calculated for 45-deg. immersed incidence, and compare the efficiency gain of the optimal design vs. operating the conventional normal incidence QWP design at 45 degree immersed incidence.

The optical efficiency using QWP at 45 degree immersed glass incidence can be modeled using conventional optical modeling software. In some cases, the quarter-wave retarder can be aligned at approximately 45 degrees to a polarization state of the reflective polarizer. In one embodiment, the alignment can be from 30 to 60 degrees; from 40 to 50 degrees; from 43 to 47 degrees; or from 44.5 to 45.5 degrees to a polarization state of the reflective polarizer. In one particular embodiment, a shift of about 11 degrees orientation offset from θ=+/−45 degrees can result in an improved efficiency for the QWP/Polarizer laminate. In this embodiment, the alignment of the QWP to the reflective polarizer can be about θ=+/−34 degrees. In some cases, the QWP film can also be made thicker, to increase the retardation from quarter-wave (90 degree retardance) to greater than 90 degrees retardance, for example, to account for the variation due to 45 degree immersion incidence. In some cases, the retardance can yield approximately quarter-wave (that is, 90 degree retardance), for example, 90 degrees+/−10% retardance. In some cases, the retarder can provide between about 90 degrees and about 120 degrees retardance.

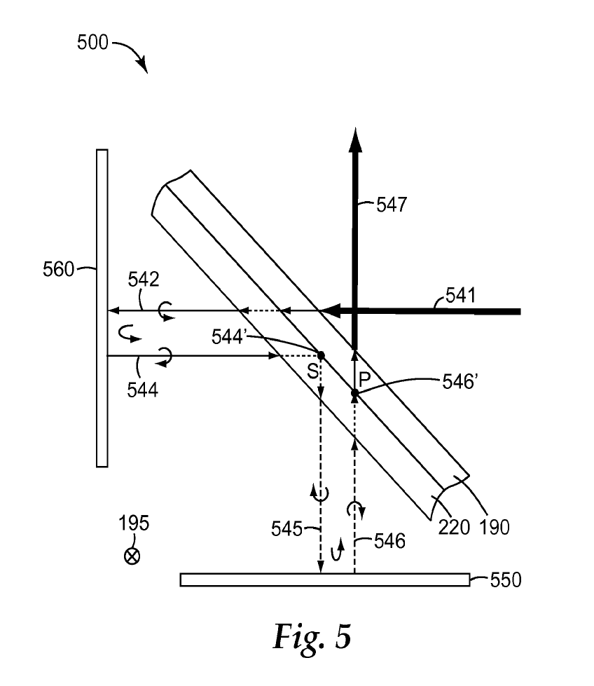

In one particular embodiment, FIG. 5 is a cross-sectional schematic of a light path 500 through a reflective polarizer laminate 390 showing the interaction with a p-polarized input light 541. The detail shown in light path 500 can be used to better understand particular embodiments of FIGS. 8-11, where retarders that are on adjacent PBS surfaces can be combined into a single retarder disposed on the diagonal of the PBS. Light path 500 includes a first and a second broadband mirror (550, 560), and the reflective polarizer laminate 390. The reflective polarizer laminate 390 includes a reflective polarizer 190 disposed immediately adjacent a quarter-wave retarder 220, disposed relative to first polarization direction 195, as described elsewhere.

The path of input p-polarized light 541 is described with reference to FIG. 5. Input p-polarized light 541 becomes an output p-polarized light 547 directed perpendicular (that is, at a 90 degree angle) to the path of input p-polarized light 541. Depending on the nature and orientation of the components within the reflective polarizer laminate 390, as described elsewhere, the output p-polarized light 547 may retain some degree of s-polarization (elliptical or linear).

Input p-polarized light 541 intersects reflective polarizer laminate 390 at an angle of approximately 45 degrees, and passes through reflective polarizer 190. The p-polarized light 541 changes to p-circular polarized light 542 after passing through quarter-wave retarder 220. P-circular polarized light 542 reflects from second broadband mirror 560, changing the direction of circular polarization, and becomes s-polarized light at position 544′ after passing through quarter-wave retarder 220. S-polarized light at position 544′ reflects from reflective polarizer 190, becomes s-circularly polarized light 545 as it passes through quarter-wave retarder 220, reflects from first broadband mirror 550 changing the direction of circular polarization, and becomes p-polarized light at position 546′ after passing through quarter wave retarder 220. P-polarized light at position 546′ passes through reflective polarizer 190 and becomes p-polarized light 547.

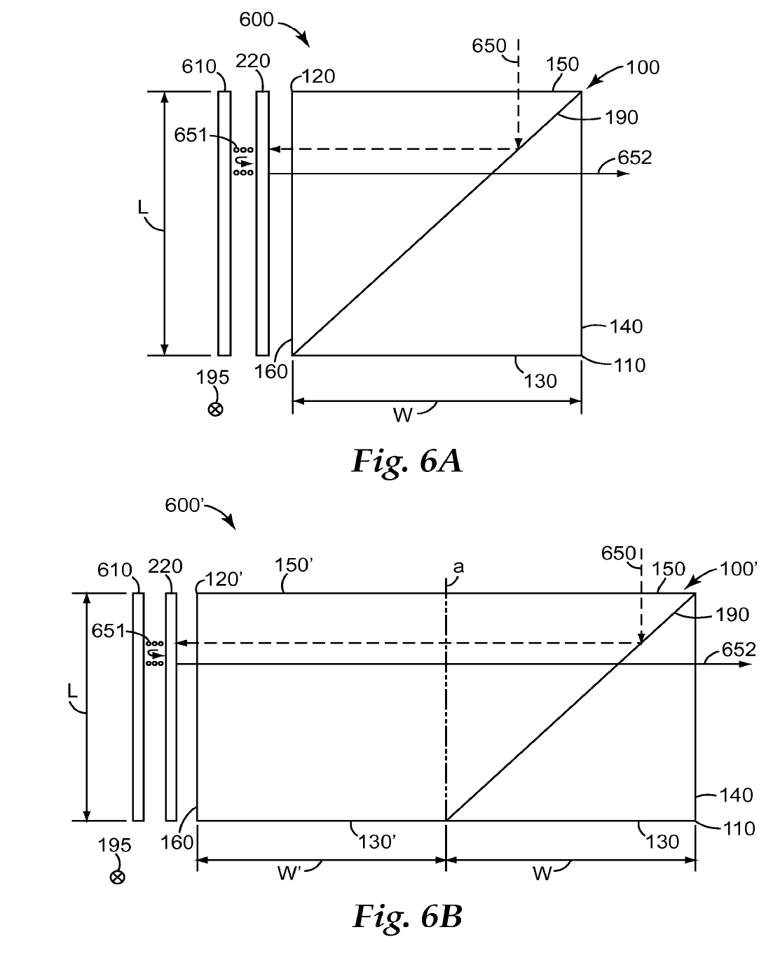

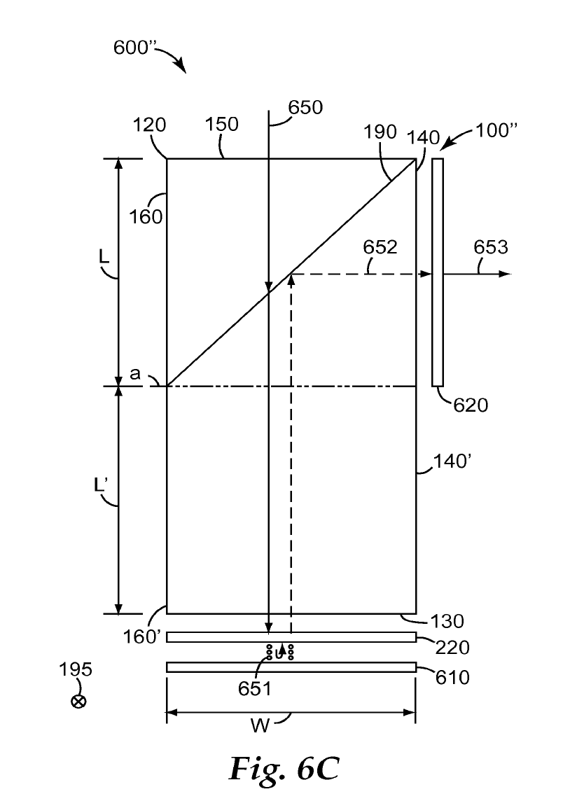

FIGS. 6A-6C are cross-sectional schematic views of an optical integrator. In one particular embodiment, FIG. 6A shows an optical integrator 600 that includes a PBS 100 having a first prism 110, a second prism 120, and a reflective polarizer 190 disposed on the diagonal between them, as described elsewhere. PBS 100 has an input surface 150, an output surface 140, a first side surface 160 and a second side surface 130. A polarization rotating reflector that includes a retarder 220 and a reflector 610 is disposed facing the first side surface 160. PBS 100 has a length L measured in a direction normal to the input surface 150 and a width W perpendicular to length L, as shown in FIG. 6A.

The reflective polarizer 190 and retarder 220 have been described elsewhere, and are aligned to the first polarization direction 195. Reflective polarizer 190 can be any reflective polarizer described herein, and retarder 220 can be a quarter-wave retarder, or can have other retardance, as described elsewhere. Reflector 610 can be any reflector, such as a mirror, and more preferably can be a broadband mirror that has a high reflectance for a wide spectrum of wavelengths, as described elsewhere.

The path of an input light, such as s-polarized input light 650 will now be traced through the optical integrator 600. S-polarized input light 650 enters PBS 100 through input surface 150, reflects from reflective polarizer 190, exits PBS 100 through first side surface 160, and changes to circular polarized light 651 as it passes through quarter-wave retarder 220. Circular polarized light 651 reflects from broadband mirror 610, changing the direction of circular polarization, becomes p-polarized light 652 as it passes through quarter-wave retarder 220, and enters PBS 100 through first side surface 160. P-polarized light 652 passes through reflective polarizer 190, and exits PBS 100 through output surface 140 as p-polarized light 652.

The path length of the input light 650 interior to optical integrator 600 is L+W, which can be determined from the geometry of PBS 100, shown in FIG. 6A to be a square having L=W. In this particular embodiment, the path length of the input light 650 is increased 2× (that is, two times) over the length of the PBS measured perpendicular to the input surface, for L=W. Also, in this particular embodiment, the input light 650 exits the optical integrator 600 in a perpendicular direction (that is, 90 degrees offset), as shown in FIG. 6A.

In one particular embodiment, FIG. 6B shows an optical integrator 600′ that includes a PBS 100′ having a first prism 110, a second elongated prism 120′, and a reflective polarizer 190 disposed on the diagonal between them, as described elsewhere. PBS 100′ has an input surface 150 that extends to position “a”, an input surface extension 150′, an output surface 140, a first side surface 160, a second side surface 130, and a second side surface extension 130′. A polarization rotating reflector that includes a retarder 220 and a reflector 610 is disposed facing the first side surface 160. PBS 100′ has a length L measured in a direction normal to the input surface 150 and a width W+W′ perpendicular to length L, as shown in FIG. 6B. Width W corresponds to the second side surface 130, and width W′ corresponds to the second side surface extension 130′.

The reflective polarizer 190 and retarder 220 have been described elsewhere, and are aligned to the first polarization direction 195. Reflective polarizer 190 can be any reflective polarizer, and retarder 220 can be a quarter-wave retarder, or can have other retardance, as described elsewhere. Reflector 610 can be any reflector, such as a mirror, and more preferably can be a broadband mirror that has a high reflectance for a wide spectrum of wavelengths, as described elsewhere.

The path of an input light, such as s-polarized input light 650 will now be traced through the optical integrator 600′. S-polarized input light 650 enters PBS 100′ through input surface 150, reflects from reflective polarizer 190, exits PBS 100′ through first side surface 160, and changes to circular polarized light 651 as it passes through quarter-wave retarder 220. Circular polarized light 651 reflects from broadband mirror 610, changing the direction of circular polarization, becomes p-polarized light 652 as it passes through quarter-wave retarder 220, and enters PBS 100′ through first side surface 160. P-polarized light 652 passes through reflective polarizer 190, and exits PBS 100′ through output surface 140 as p-polarized light 652.

The path length of the input light 650 interior to optical integrator 600′ is L+W+2W′, which can be determined from the geometry of PBS 100′, shown in FIG. 6B to be a rectangle having L=W, and a width extension W′. In this particular embodiment, the path length of the input light 650 is increased greater than 2× (that is, greater two times) over the length of the PBS measured perpendicular to the input surface, for L=W. Also, in this particular embodiment, the input light 650 exits the optical integrator 600′ in a perpendicular direction (that is, 90 degrees offset), as shown in FIG. 6B.

In one particular embodiment, FIG. 6C shows an optical integrator 600″ that includes a PBS 100″ having a first elongated prism 110′, a second prism 120, and a reflective polarizer 190 disposed on the diagonal between them, as described elsewhere. PBS 100″ has an input surface 150, an output surface 140 that extends to position “a”, an output surface extension 140′, a first side surface 160, a first side surface extension 160′, and a second side surface 130. A polarization rotating reflector that includes a retarder 220 and a reflector 610 is disposed facing the second side surface 130. PBS 100″ has a length L+L′ measured in a direction normal to the input surface 150 and a width W perpendicular to length L, as shown in FIG. 6C. Length L corresponds to the first side surface 160, and length L′ corresponds to the first side surface extension 160′.

The reflective polarizer 190 and retarder 220 have been described elsewhere, and are aligned to the first polarization direction 195. Reflective polarizer 190 can be any reflective polarizer, and retarder 220 can be a quarter-wave retarder, or can have other retardance, as described elsewhere. Reflector 610 can be any reflector, such as a mirror, and more preferably can be a broadband mirror that has a high reflectance for a wide spectrum of wavelengths, as described elsewhere.

The path of an input light, such as p-polarized input light 650 will now be traced through the optical integrator 600″. P-polarized input light 650 enters PBS 100″ through input surface 150, transmits through reflective polarizer 190, exits PBS 100″ through second side surface 130, and changes to circular polarized light 651 as it passes through quarter-wave retarder 220. Circular polarized light 651 reflects from broadband mirror 610, changing the direction of circular polarization, becomes s-polarized light 652 as it passes through quarter-wave retarder 220, and enters PBS 100″ through second side surface 130. S-polarized light 652 reflects from reflective polarizer 190, and exits PBS 100″ through output surface 140 as s-polarized light 652. S-polarized light 652 then passes through an optional half-wave retarder 620, changing to p-polarized light 653.

The path length of the input light 650 interior to optical integrator 600″ is L+W+2L′, which can be determined from the geometry of PBS 100′, shown in FIG. 6C to be a rectangle having L=W. In this particular embodiment, the path length of the input light 650 is increased greater than 2× (that is, greater two times) over the width of the PBS measured parallel to the input surface, for L=W. Also, in this particular embodiment, the input light 650 exits the optical integrator 600″ in a perpendicular direction (that is, 90 degrees offset), as shown in FIG. 6C. It is to be understood that any of the optical integrators described herein can include extensions to the length or the width of the prism faces to further increase the path length, as shown in FIGS. 6B and 6C.

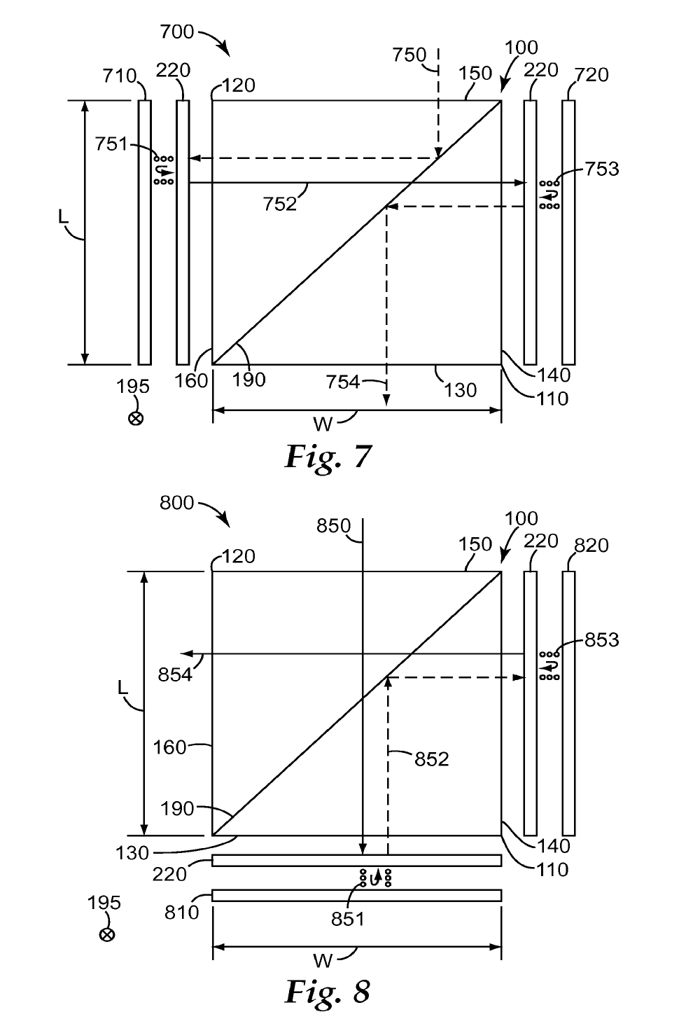

FIG. 7 is a cross-sectional schematic view of an optical integrator 700 according to one aspect of the disclosure. Optical integrator 700 includes a PBS 100 having a first prism 110, a second prism 120, and a reflective polarizer 190 disposed on the diagonal between them, as described elsewhere. PBS 100 has an input surface 150, an output surface 130, a first side surface 160 and a second side surface 140. A first polarization rotating reflector that includes a retarder 220 and a first reflector 710 is disposed facing the first side surface 160, and a second polarization rotating reflector that includes a retarder 220 and a second reflector 720 is disposed facing the second side surface 140. PBS 100 has a length L measured in a direction normal to the input surface 150 and a width W perpendicular to length L, as shown in FIG. 7.

The reflective polarizer 190 and retarders 220 have been described elsewhere, and are aligned to the first polarization direction 195. Reflective polarizer 190 can be any reflective polarizer, and retarders 220 can be quarter-wave retarders, or can have other retardance, as described elsewhere. First reflector 710 and second reflector 720 can be any reflector, such as a mirror, and more preferably can be a broadband mirror that has a high reflectance for a wide spectrum of wavelengths, as described elsewhere.

The path of an input light, such as s-polarized input light 750 will now be traced through the optical integrator 700. S-polarized input light 750 enters PBS 100 through input surface 150, reflects from reflective polarizer 190, exits PBS 100 through first side surface 160, and changes to circular polarized light 751 as it passes through quarter-wave retarder 220. Circular polarized light 751 reflects from first broadband mirror 710, changing the direction of circular polarization, becomes p-polarized light 752 as it passes through quarter-wave retarder 220, and enters PBS 100 through first side surface 160. P-polarized light 752 passes through reflective polarizer 190, exits PBS 100 through second side surface 140, changes to circular polarized light 753 as it passes through quarter-wave retarder 220, reflects from second broadband mirror 720 changing the direction of circular polarization, and becomes s-polarized light 754 as it passes through quarter-wave retarder 220. S-polarized light 754 enters PBS 100 through second side surface 140, reflects from reflective polarizer 190, and exits PBS 100 through output surface 130 as s-polarized light 754.

The path length of the input light 750 interior to optical integrator 700 is L+2W, which can be determined from the geometry of PBS 100, shown in FIG. 7 to be a square having L=W. In this particular embodiment, the path length of the input light 750 is increased 3× (that is, three times) over the length of the PBS measured perpendicular to the input surface, for L=W. Also, in this particular embodiment, the input light 750 exits the optical integrator 700 in a parallel direction (that is, 0 degrees offset), as shown in FIG. 7.

FIG. 8 is a cross-sectional schematic view of an optical integrator 800 according to one aspect of the disclosure. Optical integrator 800 includes a PBS 100 having a first prism 110, a second prism 120, and a reflective polarizer 190 disposed on the diagonal between them, as described elsewhere. PBS 100 has an input surface 150, an output surface 160, a first side surface 130 and a second side surface 140. A first polarization rotating reflector that includes a retarder 220 and a first reflector 810 is disposed facing the first side surface 130, and a second polarization rotating reflector that includes a retarder 220 and a second reflector 820 is disposed facing the second side surface 140. PBS 100 has a length L measured in a direction normal to the input surface 150 and a width W perpendicular to length L, as shown in FIG. 8.

The reflective polarizer 190 and retarders 220 have been described elsewhere, and are aligned to the first polarization direction 195. Reflective polarizer 190 can be any reflective polarizer, and retarders 220 can be quarter-wave retarders, or can have other retardance, as described elsewhere. First reflector 810 and second reflector 820 can be any reflector, such as a mirror, and more preferably can be a broadband mirror that has a high reflectance for a wide spectrum of wavelengths, as described elsewhere.

The path of an input light, such as p-polarized input light 850 will now be traced through the optical integrator 800. P-polarized input light 850 enters PBS 100 through input surface 150, transmits through reflective polarizer 190, exits PBS 100 through first side surface 130, and changes to circular polarized light 851 as it passes through quarter-wave retarder 220. Circular polarized light 851 reflects from first broadband mirror 810, changing the direction of circular polarization, becomes s-polarized light 852 as it passes through quarter-wave retarder 220, and enters PBS 100 through first side surface 130. S-polarized light 852 reflects from reflective polarizer 190, exits PBS 100 through second side surface 140, changes to circular polarized light 853 as it passes through quarter-wave retarder 220, reflects from second broadband mirror 820 changing the direction of circular polarization, and becomes p-polarized light 854 as it passes through quarter-wave retarder 220. P-polarized light 854 enters PBS 100 through second side surface 140, transmits through reflective polarizer 190, and exits PBS 100 through output surface 160 as p-polarized light 854.

The path length of the input light 850 interior to optical integrator 800 is L+2W, which can be determined from the geometry of PBS 100, shown in FIG. 8 to be a square having L=W. In this particular embodiment, the path length of the input light 850 is increased 3× (that is, three times) over the length of the PBS measured perpendicular to the input surface, for L=W. Also, in this particular embodiment, the input light 850 exits the optical integrator 800 in a perpendicular direction (that is, 90 degrees offset), as shown in FIG. 8.

In one particular embodiment, the quarter-wave retarders 220 adjacent first side surface 130 and second side surface 140 shown in FIG. 8 can instead be replaced by a single quarter-wave retarder (not shown) immediately adjacent reflective polarizer 190, as described with reference to FIGS. 4-5. In this embodiment, the path length of the input light 850 described above is the same.

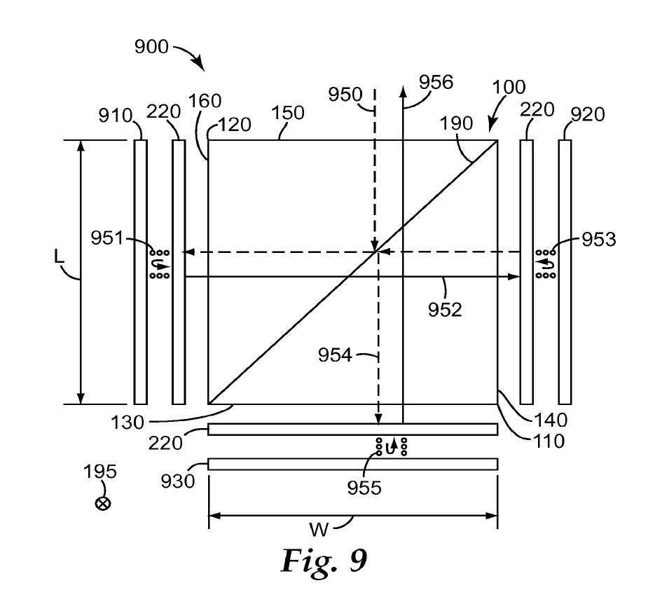

FIG. 9 is a cross-sectional schematic view of an optical integrator 900 according to one aspect of the disclosure. Optical integrator 900 includes a PBS 100 having a first prism 110, a second prism 120, and a reflective polarizer 190 disposed on the diagonal between them, as described elsewhere. PBS 100 has a first surface 150, a first side surface 160, a second side surface 140, and a third side surface 130. A first polarization rotating reflector that includes a retarder 220 and a first reflector 910 is disposed facing the first side surface 130, a second polarization rotating reflector that includes a retarder 220 and a second reflector 920 is disposed facing the second side surface 140, and a third polarization rotating reflector that includes a retarder 220 and a third reflector 930 is disposed facing the third side surface 130. PBS 100 has a length L measured in a direction normal to the first surface 150 and a width W perpendicular to length L, as shown in FIG. 9.

The reflective polarizer 190 and retarders 220 have been described elsewhere, and are aligned to the first polarization direction 195. Reflective polarizer 190 can be any reflective polarizer, and retarders 220 can be quarter-wave retarders, or can have other retardance, as described elsewhere. First reflector 910, second reflector 920, and third reflector 930 can be any reflector, such as a mirror, and more preferably can be a broadband mirror that has a high reflectance for a wide spectrum of wavelengths, as described elsewhere.

The path of an input light, such as s-polarized input light 950 will now be traced through the optical integrator 900. S-polarized input light 950 enters PBS 100 through first surface 150, reflects from reflective polarizer 190, exits PBS 100 through first side surface 160, and changes to circular polarized light 951 as it passes through quarter-wave retarder 220. Circular polarized light 951 reflects from first broadband mirror 910, changing the direction of circular polarization, becomes p-polarized light 952 as it passes through quarter-wave retarder 220, and enters PBS 100 through first side surface 160. P-polarized light 952 passes through reflective polarizer 190, exits PBS 100 through second side surface 140, changes to circular polarized light 953 as it passes through quarter-wave retarder 220, reflects from second broadband mirror 920 changing the direction of circular polarization, and becomes s-polarized light 954 as it passes through quarter-wave retarder 220. S-polarized light 954 enters PBS 100 through second side surface 140, reflects from reflective polarizer 190, and exits PBS 100 through third side surface 130. S-polarized light 954 changes to circular polarized light 955 as it passes through quarter-wave retarder 220, reflects from third broadband mirror 930 changing the direction of circular polarization, and becomes p-polarized light 956 as it passes through retarder 220. P-polarized light 956 enters PBS 100 through third side surface 130, passes through reflective polarizer 190, and exits PBS 100 through first surface 150.

The path length of the input light 950 interior to optical integrator 900 is 2L+2W, which can be determined from the geometry of PBS 100, shown in FIG. 9 to be a square having L=W. In this particular embodiment, the path length of the input light 950 is increased 4× (that is, four times) over the length of the PBS measured perpendicular to the input surface, for L+W. Also, in this particular embodiment, the input light 950 exits the optical integrator 800 through the first surface 150, but in a reversed direction (that is, 180 degrees offset), as shown in FIG. 9.

In one particular embodiment, the quarter-wave retarders 220 adjacent third side surface 130 and second side surface 140 shown in FIG. 9 can instead be replaced by a single quarter-wave retarder (not shown) immediately adjacent reflective polarizer 190, as described with reference to FIGS. 4-5. In this embodiment, the path length of the input light 950 described above is the same.

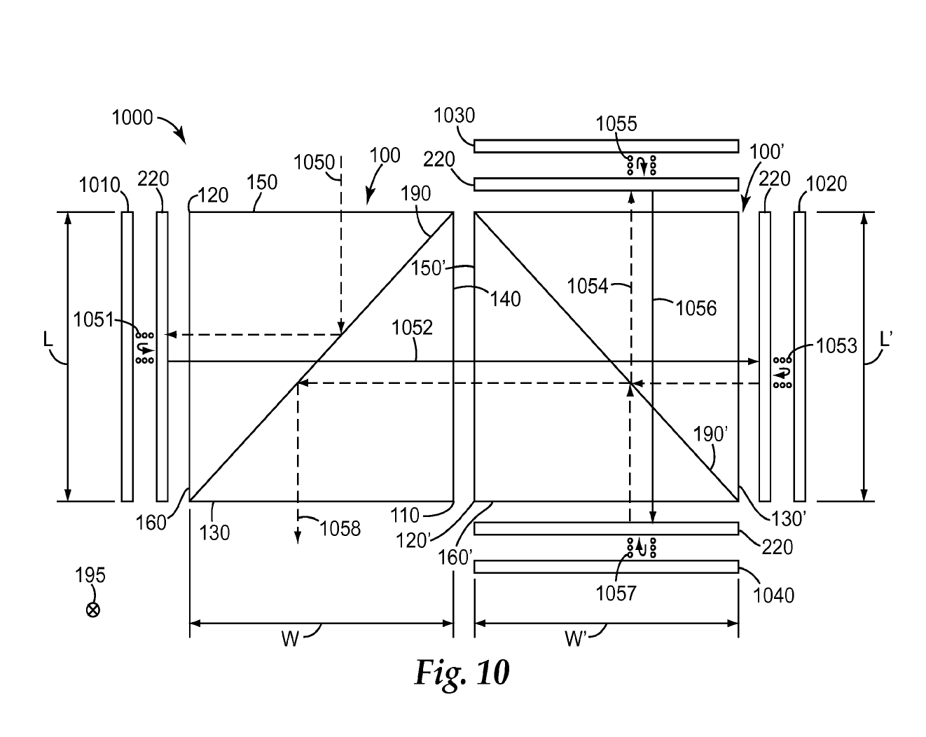

FIG. 10 is a cross-sectional schematic view of an optical integrator 1000 according to one aspect of the disclosure. Optical integrator 1000 includes a first PBS 100 having a first prism 110, a second prism 120, and a first reflective polarizer 190 disposed on the diagonal between them, as described elsewhere. PBS 100 has a first input surface 150, a first output surface 140, a first side surface 160 and a second output surface 130. A first polarization rotating reflector that includes a retarder 220 and a first reflector 1010 is disposed facing the first side surface 160. PBS 100 has a length L measured in a direction normal to the first input surface 150 and a width W perpendicular to length L, as shown in FIG. 10.

Optical integrator 1000 further includes a second PBS 100′ having a third prism 110′, a fourth prism 120′, and a second reflective polarizer 190′ disposed on the diagonal between them, as described elsewhere. Second PBS 100′ has a second input surface 150′, a first side surface 130′, a second side surface 140′, and a third side surface 160′. The second input surface 150′ of the second PBS 100′ is disposed facing the first output surface 140 of the first PBS 100. A second polarization rotating reflector that includes a retarder 220 and a second reflector 1020 is disposed facing the first side surface 130′, a third polarization rotating reflector that includes a retarder 220 and a third reflector 1030 is disposed facing the second side surface 140′, and a fourth polarization rotating reflector that includes a retarder 220 and a fourth reflector 1040 is disposed facing the third side surface 130′. Second PBS 100′ has a length L′ measured in a direction normal to the first surface 150 of the first PBS 100, and a width W′ perpendicular to length L′, as shown in FIG. 10.

The first and second reflective polarizers 190, 190′ and retarders 220 have been described elsewhere, and are aligned to the first polarization direction 195. First and second reflective polarizers 190, 190′ can be any reflective polarizer, and retarder 220 can be a quarter-wave retarder, or can have other retardance, as described elsewhere. First through fourth reflectors 1010, 1020, 1030, 1040 can be any reflector, such as a mirror, and more preferably can be a broadband mirror that has a high reflectance for a wide spectrum of wavelengths, as described elsewhere.

The path of an input light, such as s-polarized input light 1050 will now be traced through the optical integrator 1000. S-polarized input light 1050 enters first PBS 100 through input surface 150, reflects from first reflective polarizer 190, exits first PBS 100 through first side surface 160, and changes to circular polarized light 1051 as it passes through quarter-wave retarder 220. Circular polarized light 1051 reflects from first broadband mirror 1010, changing the direction of circular polarization, becomes p-polarized light 1052 as it passes through quarter-wave retarder 220, and enters first PBS 100 through first side surface 160. P-polarized light 1052 passes through reflective polarizer 190, exits first PBS 100 through first output surface 140, and enters second PBS 100′ through second input surface 150′.

P-polarized light 1052 enters second PBS 100′ through second input surface 150′, passes through second reflective polarizer 190′, exits second PBS 100′ through first side surface 130′, and changes to circular polarized light 1053 as it passes through quarter-wave retarder 220. Circular polarized light 1053 reflects from second broadband mirror 1020, changing the direction of circular polarization, becomes s-polarized light 1054 as it passes through quarter-wave retarder 220, and enters second PBS 100′ through first side surface 130′. S-polarized light 1054 reflects from second reflective polarizer 190′, exits second PBS 100′ through second side surface 140′, changes to circular polarized light 1055 as it passes through quarter-wave retarder 220, reflects from third broadband mirror 1030 changing the direction of circular polarization, and becomes p-polarized light 1056 as it passes through quarter-wave retarder 220. P-polarized light 1056 enters second PBS 100′ through second side surface 140′, passes through second reflective polarizer 190′, and exits second PBS 100′ through third side surface 160′. P-polarized light 1056 changes to circular polarized light 1057 as it passes through quarter-wave retarder 220, reflects from fourth broadband mirror 1040 changing the direction of circular polarization, and becomes s-polarized light 1058 as it passes through retarder 220. S-polarized light 1058 enters second PBS 100′ through third side surface 160′, reflects from second reflective polarizer 190′, and exits second PBS 100′ through second input surface 150′. S-polarized light 1058 enters first PBS 100 through first output surface 140, reflects from first reflective polarizer 190, and exits first PBS 100 through second output surface 130 as s-polarized light 1058.

The path length of the input light 1050 interior to optical integrator 1000 is L+2W+2L′+2W′, which can be determined from the geometry of first and second PBS 100, 100′ shown in FIG. 10 for the case where each has a square cross-section having L=W and L′=W′, respectively. In this particular embodiment, the path length of the input light 1050 is increased 7× (that is, seven times) over the length of the PBS measured perpendicular to the input surface, for L=L'=W=W'. Also, in this particular embodiment, the input light 1050 exits the optical integrator 1000 in a parallel direction (that is, 0 degrees offset), as shown in FIG. 10.

In one particular embodiment, the quarter-wave retarders 220 adjacent first side surface 130′ and second side surface 140′ of second PBS 100′ shown in FIG. 10 can instead be replaced by a single quarter-wave retarder (not shown) immediately adjacent second reflective polarizer 190′, as described with reference to FIGS. 4-5. In this embodiment, the path length of the input light 1050 described above is the same.

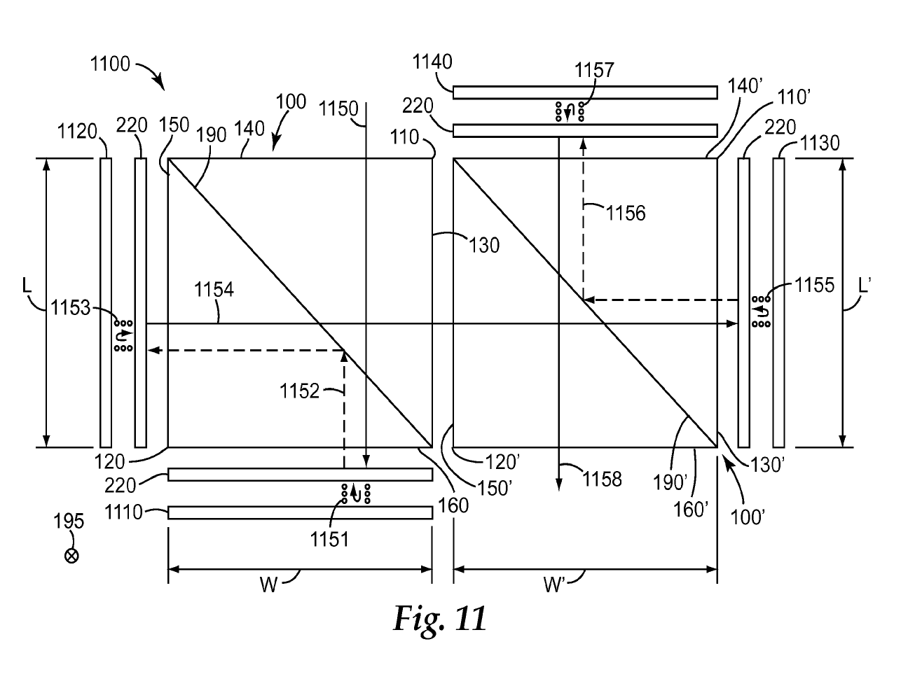

FIG. 11 is a cross-sectional schematic view of an optical integrator 1100 according to one aspect of the disclosure. Optical integrator 1100 includes a first PBS 100 having a first prism 110, a second prism 120, and a first reflective polarizer 190 disposed on the diagonal between them, as described elsewhere. First PBS 100 has a first input surface 140, a first output surface 130, a first side surface 160 and a second side surface 150. A first polarization rotating reflector that includes a retarder 220 and a first reflector 1110 is disposed facing the first side surface 160, and a second polarization rotating reflector that includes a retarder 220 and a second reflector 1120 is disposed facing the second side surface 150. First PBS 100 has a length L measured in a direction normal to the first input surface 140 and a width W perpendicular to length L, as shown in FIG. 11.

Optical integrator 1100 further includes a second PBS 100′ having a third prism 110′, a fourth prism 120′, and a second reflective polarizer 190′ disposed on the diagonal between them, as described elsewhere. Second PBS 100′ has a second input surface 150′, a second output surface 160′, a first side surface 130′ and a second side surface 140′. The second input surface 150′ of second PBS 100′ is disposed facing the first output surface 130 of first PBS 100. A third polarization rotating reflector that includes a retarder 220 and a third reflector 1130 is disposed facing the first side surface 130′, and a fourth polarization rotating reflector that includes a retarder 220 and a fourth reflector 1140 is disposed facing the second side surface 140′. Second PBS 100′ has a length L′ measured in a direction normal to the first input surface 150 of first PBS 100, and a width W′ perpendicular to length L, as shown in FIG. 11.

The first and second reflective polarizers 190, 190′ and retarders 220 have been described elsewhere, and are aligned to the first polarization direction 195. First and second reflective polarizers 190, 190′ can be any reflective polarizer, and retarders 220 can be quarter-wave retarders, or can have other retardance, as described elsewhere. First, second, third and fourth reflectors 1110, 1120, 1130, 1140 can be any reflector, such as a mirror, and more preferably can be a broadband mirror that has a high reflectance for a wide spectrum of wavelengths, as described elsewhere.

The path of an input light, such as p-polarized input light 1150 will now be traced through the optical integrator 1100. P-polarized input light 1150 enters first PBS 100 through first input surface 140, transmits through first reflective polarizer 190, exits first PBS 100 through first side surface 160, and changes to circular polarized light 1151 as it passes through quarter-wave retarder 220. Circular polarized light 1151 reflects from first broadband mirror 1110, changing the direction of circular polarization, becomes s-polarized light 1152 as it passes through quarter-wave retarder 220, and enters first PBS 100 through first side surface 160. S-polarized light 1152 reflects from first reflective polarizer 190, exits first PBS 100 through second side surface 150, changes to circular polarized light 1153 as it passes through quarter-wave retarder 220, reflects from second broadband mirror 1120 changing the direction of circular polarization, and becomes p-polarized light 1154 as it passes through quarter-wave retarder 220. P-polarized light 1154 enters first PBS 100 through second side surface 150, transmits through first reflective polarizer 190, and exits first PBS 100 through first output surface 130 as p-polarized light 1154.

P-polarized light 1154 enters second PBS 100′ through second input surface 150′, transmits through second reflective polarizer 190′, exits second PBS 100′ through first side surface 130′, and changes to circular polarized light 1155 as it passes through quarter-wave retarder 220. Circular polarized light 1155 reflects from third broadband mirror 1130, changing the direction of circular polarization, becomes s-polarized light 1156 as it passes through quarter-wave retarder 220, and enters second PBS 100′ through first side surface 130′. S-polarized light 1156 reflects from second reflective polarizer 190′, exits second PBS 100′ through second side surface 140′, changes to circular polarized light 1157 as it passes through quarter-wave retarder 220, reflects from fourth broadband mirror 1140 changing the direction of circular polarization, and becomes p-polarized light 1158 as it passes through quarter-wave retarder 220. P-polarized light 1158 enters second PBS 100′ through second side surface 140′, transmits through second reflective polarizer 190′, and exits second PBS 100′ through second output surface 160′ as p-polarized light 1158.

The path length of the input light 1150 interior to optical integrator 1100 is L+2W+2W′+L, which can be determined from the geometry of first and second PBS 100, 100′ shown in FIG. 11 for the case where each has a square cross-section having L=W and L′=W′, respectively. In this particular embodiment, the path length of the input light 1150 is increased 6× (that is, six times) over the length of the PBS measured perpendicular to the input surface, for L=L′=W=W′. Also, in this particular embodiment, the input light 1150 exits the optical integrator 1100 in a parallel direction (that is, 0 degrees offset), as shown in FIG. 11.

In one particular embodiment, the quarter-wave retarders 220 adjacent first side surface 160 and second side surface 150 of first PBS 100, and also first side surface 130′ and second side surface 140′ of second PBS 100′ shown in FIG. 10 can instead each be replaced by a single quarter-wave retarder (not shown) immediately adjacent first and second reflective polarizer 190, 190′, respectively, as described with reference to FIGS. 4-5. In this embodiment, the path length of the input light 1150 described above is the same.

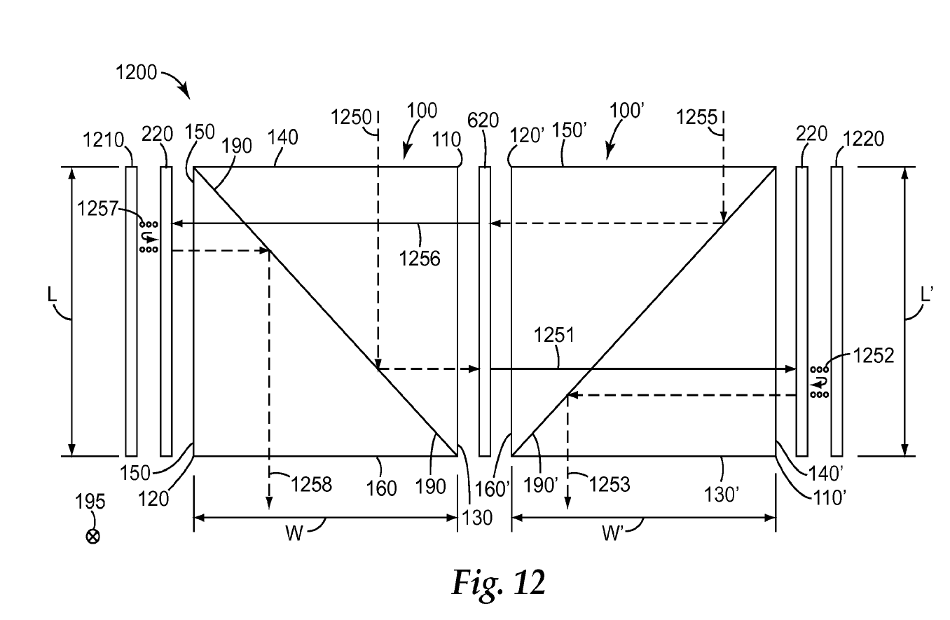

FIG. 12 is a cross-sectional schematic view of an optical integrator 1200 according to one aspect of the disclosure. Optical integrator 1200 includes a first PBS 100 having a first prism 110, a second prism 120, and a first reflective polarizer 190 disposed on the diagonal between them, as described elsewhere. First PBS 100 has a first input surface 140, a first output surface 130, a first side surface 150 and a second output surface 160. A first polarization rotating reflector that includes a retarder 220 and a first reflector 1210 is disposed facing the first side surface 150. First PBS 100 has a length L measured in a direction normal to the first input surface 140 and a width W perpendicular to length L, as shown in FIG. 12.

Optical integrator 1200 further includes a second PBS 100′ having a third prism 110′, a fourth prism 120′, and a second reflective polarizer 190′ disposed on the diagonal between them, as described elsewhere. Second PBS 100′ has a second input surface 150′, a first output surface 160′, a second output surface 130′ and a first side surface 140′. The first output surface 160′ of second PBS 100′ is disposed facing the first output surface 130 of first PBS 100, and a half-wave retarder 620 is disposed between them. A second polarization rotating reflector that includes a retarder 220 and a second reflector 1220 is disposed facing the first side surface 140′. Second PBS 100′ has a length L′ measured in a direction normal to the first input surface 150′ of second PBS 100′, and a width W′ perpendicular to length L, as shown in FIG. 12.

The first and second reflective polarizers 190, 190′ and retarders 220 have been described elsewhere, and are aligned to the first polarization direction 195. First and second reflective polarizers 190, 190′ can be any reflective polarizer, and retarders 220 can be quarter-wave retarders, or can have other retardance, as described elsewhere. First and second reflectors 1210, 1220, can be any reflector, such as a mirror, and more preferably can be a broadband mirror that has a high reflectance for a wide spectrum of wavelengths, as described elsewhere.

The path of a first input light, such as first s-polarized input light 1250 will now be traced through the optical integrator 1200. First s-polarized input light 1250 enters first PBS 100 through first input surface 140, reflects from first reflective polarizer 190, exits first PBS 100 through first output surface 130, and changes to p-polarized first light 1251 as it passes through half-wave retarder 620. P-polarized first light 1251 enters second PBS 100′ through first output surface 160′, passes through second reflective polarizer 190′, exits second PBS 100′ through first side surface 140′, and changes to circular polarized first light 1252 as it passes through quarter-wave retarder 220. Circular polarized first light 1252 reflects from second broadband mirror 1220 changing the direction of circular polarization, becomes s-polarized first light 1253 as it passes through quarter-wave retarder 220, enters second PBS 100′ through first side surface 140′, reflects from second reflective polarizer 190′, and exits second PBS 100′ through second output surface 130′ as s-polarized first light 1253.

The path of a second input light, such as second s-polarized input light 1255 will now be traced through the optical integrator 1200. Second s-polarized input light 1255 enters second PBS 100′ through first input surface 150′, reflects from second reflective polarizer 190′, exits second PBS 100′ through first output surface 160′, and changes to p-polarized second light 1256 as it passes through half-wave retarder 620. P-polarized second light 1256 enters first PBS 100 through first output surface 130, passes through first reflective polarizer 190, exits first PBS 100 through first side surface 150, and changes to circular polarized second light 1257 as it passes through quarter-wave retarder 220. Circular polarized second light 1257 reflects from first broadband mirror 1210 changing the direction of circular polarization, becomes s-polarized second light 1258 as it passes through quarter-wave retarder 220, enters first PBS 100 through first side surface 150, reflects from first reflective polarizer 190, and exits first PBS 100 through second output surface 160 as s-polarized second light 1258.

The path length of each of the first input light 1250 and the second input light 1255 interior to optical integrator 1200 is L+2W′ and L′+2W, respectively, which can be determined from the geometry of first and second PBS 100, 100′ shown in FIG. 12 for the case where each has a square cross-section having L=W and L′=W′, respectively. In this particular embodiment, the path length of each of the first and second input lights 1250, 1255 is increased 3× (that is, three times) over the length of the PBS measured perpendicular to the input surface, for L=L′=W=W′. Also, in this particular embodiment, each of the first and second input lights 1250, 1255 exit the optical integrator 1200 in a parallel direction (that is, 0 degrees offset), as shown in FIG. 12.

Following are a list of embodiments of the present disclosure.

Item 1 is an optical integrator, comprising: a polarizing beam splitter (PBS) having an input surface disposed to receive an input light beam normal to the input surface, an output surface, and a first and a second side surface; a reflective polarizer aligned to a first polarization direction and disposed within the PBS to intercept the input light beam at an angle of approximately 45 degrees; and a first polarization rotating reflector disposed facing the first side surface, wherein the reflective polarizer and the polarization rotating reflector cooperate so that a path length of the input light beam from the input surface to the output surface within the optical integrator is at least about two times a length of the PBS measured normal to the input surface.

Item 2 is the optical integrator of item 1, wherein the input surface and the output surface are on adjacent surfaces of the PBS.

Item 3 is the optical integrator of item 1, further comprising a second polarization rotating reflector disposed facing the second side surface.

Item 4 is the optical integrator of item 3, wherein the input surface and the output surface are on opposing surfaces of the PBS, and the reflective polarizer and the polarization rotating reflectors cooperate so that a path length of the input light beam from the input surface to the output surface within the optical integrator is at least about three times a length of the PBS measured normal to the input surface.

Item 5 is the optical integrator of item 3, wherein the input surface and the output surface are on adjacent surfaces of the PBS, and the reflective polarizer and the polarization rotating reflectors cooperate so that a path length of the input light beam from the input surface to the output surface within the optical integrator is at least about three times a length of the PBS measured normal to the input surface.

Item 6 is an optical integrator, comprising: a polarizing beam splitter (PBS) having an first surface disposed to receive an input light beam normal to the first surface, a first side surface, a second side surface, and a third side surface; a reflective polarizer aligned to a first polarization direction and disposed within the PBS to intercept the input light beam at an angle of approximately 45 degrees; and a first, a second, and a third polarization rotating reflector disposed facing the second, third and fourth side surfaces, respectively, wherein the reflective polarizer and the polarization rotating reflectors cooperate so that a path length of the input light beam from the first surface, through the optical integrator, and returning to the first surface is at least about four times a length of the PBS measured normal to the first surface.

Item 7 is an optical integrator, comprising: a first polarizing beam splitter (PBS), including: a first input surface disposed to receive an input light beam normal to the input surface, a first output surface adjacent the first input surface, a second output surface opposite the first input surface, and a first side surface; a first reflective polarizer aligned to a first polarization direction and disposed within the first PBS to intercept the input light beam at an angle of approximately 45 degrees; a first polarization rotating reflector disposed facing the first side surface; a second PBS, including: a second input surface disposed facing the first output surface and capable of receiving a first output light beam from the first PBS, and three side surfaces; a second reflective polarizer aligned to the first polarization direction and disposed within the second PBS to intercept the first output light beam at an angle of approximately 45 degrees; and a second, a third, and a fourth polarization rotating reflector disposed facing each of the three side surfaces, wherein the reflective polarizers and the polarization rotating reflectors cooperate so that a path length of the input light beam from the first input surface to the second output surface within the optical integrator is at least about seven times a length of the first PBS measured normal to the input surface.

Item 8 is an optical integrator, comprising: a first and a second polarizing beam splitter (PBS), each PBS comprising: an input surface disposed to receive an input light beam normal to the input surface, an output surface adjacent the input surface, and two side surfaces; a reflective polarizer aligned to a first polarization direction and disposed within the PBS to intercept the input light beam at an angle of approximately 45 degrees; a first and a second polarization rotating reflector disposed facing each of the two side surfaces; wherein the output surface of the first PBS faces the input surface of the second PBS, and further wherein the reflective polarizers and the polarization rotating reflectors cooperate so that a path length of the input light beam from the input surface of the first PBS to the output surface of the second PBS within the optical integrator is at least about six times a length of the first PBS measured normal to the input surface.

Item 9 is an optical integrator, comprising: a polarizing beam splitter (PBS) having an input surface disposed to receive an input light beam normal to the input surface, an output surface adjacent the input surface, and two side surfaces; a reflective polarizer aligned to a first polarization direction and disposed within the PBS to intercept the input light beam at an angle of approximately 45 degrees; a retarder disposed immediately adjacent the reflective polarizer and opposite the input surface, the retarder aligned at an angle of approximately 45 degrees to the first polarization direction; and a first and a second broadband mirror disposed facing each of the two side surfaces; wherein the reflective polarizer, the retarder, and the broadband mirrors cooperate so that a path length of the input light beam from the input surface to the output surface within the optical integrator is at least about three times a length of the PBS measured normal to the input surface.

Item 10 is an optical integrator, comprising: a polarizing beam splitter (PBS) having a first surface disposed to receive an input light beam normal to the first surface, a second surface adjacent the first surface, and two side surfaces; a reflective polarizer aligned to a first polarization direction and disposed within the PBS to intercept the input light beam at an angle of approximately 45 degrees; a retarder disposed immediately adjacent the reflective polarizer and opposite the input surface, the retarder aligned at an angle of approximately 45 degrees to the first polarization direction; a first and a second broadband mirror disposed facing each of the two side surfaces; and a polarization rotating reflector disposed facing the second surface, wherein the reflective polarizer, the retarder, the polarization rotating reflector, and the broadband mirrors cooperate so that a path length of the input light beam from the input surface to the output surface within the optical integrator is at least about three times a length of the PBS measured normal to the input surface.

Item 11 is an optical integrator, comprising: a first polarizing beam splitter (PBS), including: a first input surface disposed to receive an input light beam normal to the input surface, a first output surface adjacent the first input surface, a second output surface opposite the first input surface, and a first side surface; a first reflective polarizer aligned to a first polarization direction and disposed within the first PBS to intercept the input light beam at an angle of approximately 45 degrees; a first polarization rotating reflector disposed facing the first side surface; a second PBS, including: a second input surface disposed facing the first output surface and capable of receiving a first output light beam from the first PBS, a first, a second, and a third side surfaces; a second reflective polarizer aligned to the first polarization direction and disposed within the second PBS to intercept the first output light beam at an angle of approximately 45 degrees; a retarder disposed immediately adjacent the second reflective polarizer, opposite the second input surface; a first and a second broadband mirror disposed facing the first and the second side surfaces, respectively, adjacent the retarder; and a second polarization rotating reflector disposed facing the third side surface, wherein the reflective polarizers, the polarization rotating reflectors, the retarder, and the broadband mirrors cooperate so that a path length of the input light beam from the first input surface to the second output surface within the optical integrator is at least about seven times a length of the first PBS measured normal to the input surface.

Item 12 is an optical integrator, comprising: a first and a second polarizing beam splitter (PBS), each PBS comprising: an input surface disposed to receive an input light beam normal to the input surface, an output surface adjacent the input surface, and two side surfaces; a reflective polarizer aligned to a first polarization direction and disposed within the PBS to intercept the input light beam at an angle of approximately 45 degrees; a retarder disposed immediately adjacent the reflective polarizer and opposite the input surface, the retarder aligned at an angle of approximately 45 degrees to the first polarization direction; and a first and a second broadband mirror disposed facing each of the two side surfaces; wherein the output surface of the first PBS is facing the input surface of the second PBS, and further wherein the reflective polarizers, the retarders, and the broadband mirrors cooperate so that a path length of the input light beam from the input surface to the output surface within the optical integrator is at least about six times a length of the PBS measured normal to the input surface.

Item 13 is an optical integrator, comprising: a first and a second polarizing beam splitter (PBS), each PBS comprising: an input surface disposed to receive an input light beam normal to the input surface, a first output surface, a second output surface opposite the input surface, and a side surface; a reflective polarizer aligned to a first polarization direction and disposed within the PBS to intercept the input light beam at an angle of approximately 45 degrees; a first polarization rotating reflector disposed facing the side surface, wherein the first output surface of the first PBS faces the first output surface of the second PBS; and a half-wave retarder disposed between the first output surface of the first PBS and the first output surface of the second PBS, wherein the reflective polarizers, the polarization rotating reflectors, and the half-wave retarder cooperate so that a path length of the input light beam from the input surface of the first PBS to the second output surface of the second PBS within the optical integrator is at least about three times a length of the first PBS measured normal to the input surface.

Item 14 is the optical integrator of any of items 1, 6, 7, 8, 9, 10, 11, 12, or 13, wherein the input light beam is polarized.

Item 15 is the optical integrator of any of items 1, 3, 6, 7, 8, 9, 10, 11, 12, or 13, wherein each polarization rotating reflector comprises a retarder and a broadband mirror.

Item 16 is the optical integrator of item 15, wherein the retarder is a quarter-wave retarder aligned at an angle of approximately 45 degrees to the first polarization direction.

Item 17 is the optical integrator of any of items 1, 6, 7, 8, 9, 10, 11, 12, or 13, wherein each reflective polarizer is selected from a multilayer optical film (MOF) reflective polarizer, a wire grid reflective polarizer, and a MacNeille reflective polarizer.

Item 18 is the optical integrator of item 17, wherein the MOF reflective polarizer is a polymeric MOF reflective polarizer.

Item 19 is the optical integrator of any of items 1, 6, 7, 8, 9, 10, 11, 12, or 13, wherein each PBS comprises a first and a second prism having the reflective polarizer disposed on a diagonal surface between them.

Item 20 is the optical integrator of any of items 1, 6, 7, 8, 9, 10, 11, 12, or 13, wherein each PBS comprises the reflective polarizer disposed as a pellicle.

Although the present invention has been described with reference to preferred embodiments, workers skilled in the art will recognize that changes may be made in form and detail without departing from the spirit and scope of the invention.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical integrator, comprising:
a polarizing beam splitter (PBS) having an input surface disposed to receive an input light beam normal to the input surface, an output surface, and a first and a second side surface;
a reflective polarizer aligned to a first polarization direction and disposed within the PBS to intercept the input light beam at an angle of approximately 45 degrees; and
a first polarization rotating reflector disposed facing the first side surface,
wherein the reflective polarizer and the polarization rotating reflector cooperate so that a path length of the input light beam from the input surface to the output surface within the optical integrator is at least about two times a length of the PBS measured normal to the input surface.

2. The optical integrator of claim 1, wherein the input surface and the output surface are on adjacent surfaces of the PBS.

3. The optical integrator of claim 1, further comprising a second polarization rotating reflector disposed facing the second side surface.

4. The optical integrator of claim 3, wherein the input surface and the output surface are on opposing surfaces of the PBS, and the reflective polarizer and the polarization rotating reflectors cooperate so that a path length of the input light beam from the input surface to the output surface within the optical integrator is at least about three times a length of the PBS measured normal to the input surface.

5. The optical integrator of claim 3, wherein the input surface and the output surface are on adjacent surfaces of the PBS, and the reflective polarizer and the polarization rotating reflectors cooperate so that a path length of the input light beam from the input surface to the output surface within the optical integrator is at least about three times a length of the PBS measured normal to the input surface.

6. An optical integrator, comprising:
a polarizing beam splitter (PBS) having an first surface disposed to receive an input light beam normal to the first surface, a first side surface, a second side surface, and a third side surface;
a reflective polarizer aligned to a first polarization direction and disposed within the PBS to intercept the input light beam at an angle of approximately 45 degrees; and
a first, a second, and a third polarization rotating reflector disposed facing the second, third and fourth side surfaces, respectively,
wherein the reflective polarizer and the polarization rotating reflectors cooperate so that a path length of the input light beam from the first surface, through the optical integrator, and returning to the first surface is at least about four times a length of the PBS measured normal to the first surface.

7. An optical integrator, comprising:
a first polarizing beam splitter (PBS), including:
a first input surface disposed to receive an input light beam normal to the input surface, a first output surface adjacent the first input surface, a second output surface opposite the first input surface, and a first side surface;
a first reflective polarizer aligned to a first polarization direction and disposed within the first PBS to intercept the input light beam at an angle of approximately 45 degrees;
a first polarization rotating reflector disposed facing the first side surface;
a second PBS, including:
a second input surface disposed facing the first output surface and capable of receiving a first output light beam from the first PBS, and three side surfaces;
a second reflective polarizer aligned to the first polarization direction and disposed within the second PBS to intercept the first output light beam at an angle of approximately 45 degrees; and
a second, a third, and a fourth polarization rotating reflector disposed facing each of the three side surfaces,
wherein the reflective polarizers and the polarization rotating reflectors cooperate so that a path length of the input light beam from the first input surface to the second output surface within the optical integrator is at least about seven times a length of the first PBS measured normal to the input surface.

8. An optical integrator, comprising:
a first and a second polarizing beam splitter (PBS), each PBS comprising:
an input surface disposed to receive an input light beam normal to the input surface, an output surface adjacent the input surface, and two side surfaces;
a reflective polarizer aligned to a first polarization direction and disposed within the PBS to intercept the input light beam at an angle of approximately 45 degrees;
a first and a second polarization rotating reflector disposed facing each of the two side surfaces;
wherein the output surface of the first PBS faces the input surface of the second PBS, and further
wherein the reflective polarizers and the polarization rotating reflectors cooperate so that a path length of the input light beam from the input surface of the first PBS to the output surface of the second PBS within the optical integrator is at least about six times a length of the first PBS measured normal to the input surface.

9. An optical integrator, comprising:
a polarizing beam splitter (PBS) having an input surface disposed to receive an input light beam normal to the input surface, an output surface adjacent the input surface, and two side surfaces;
a reflective polarizer aligned to a first polarization direction and disposed within the PBS to intercept the input light beam at an angle of approximately 45 degrees;
a retarder disposed immediately adjacent the reflective polarizer and opposite the input surface, the retarder aligned at an angle of approximately 45 degrees to the first polarization direction; and
a first and a second broadband mirror disposed facing each of the two side surfaces;
wherein the reflective polarizer, the retarder, and the broadband mirrors cooperate so that a path length of the input light beam from the input surface to the output surface within the optical integrator is at least about three times a length of the PBS measured normal to the input surface.

10. An optical integrator, comprising:
a polarizing beam splitter (PBS) having a first surface disposed to receive an input light beam normal to the first surface, a second surface adjacent the first surface, and two side surfaces;
a reflective polarizer aligned to a first polarization direction and disposed within the PBS to intercept the input light beam at an angle of approximately 45 degrees;
a retarder disposed immediately adjacent the reflective polarizer and opposite the input surface, the retarder aligned at an angle of approximately 45 degrees to the first polarization direction;
a first and a second broadband mirror disposed facing each of the two side surfaces; and
a polarization rotating reflector disposed facing the second surface,
wherein the reflective polarizer, the retarder, the polarization rotating reflector, and the broadband mirrors cooperate so that a path length of the input light beam from the input surface to the output surface within the optical integrator is at least about three times a length of the PBS measured normal to the input surface.

11. An optical integrator, comprising:
a first polarizing beam splitter (PBS), including:
a first input surface disposed to receive an input light beam normal to the input surface, a first output surface adjacent the first input surface, a second output surface opposite the first input surface, and a first side surface;
a first reflective polarizer aligned to a first polarization direction and disposed within the first PBS to intercept the input light beam at an angle of approximately 45 degrees;
a first polarization rotating reflector disposed facing the first side surface;
a second PBS, including:
a second input surface disposed facing the first output surface and capable of receiving a first output light beam from the first PBS, a first, a second, and a third side surfaces;
a second reflective polarizer aligned to the first polarization direction and disposed within the second PBS to intercept the first output light beam at an angle of approximately 45 degrees;
a retarder disposed immediately adjacent the second reflective polarizer, opposite the second input surface;
a first and a second broadband mirror disposed facing the first and the second side surfaces, respectively, adjacent the retarder; and
a second polarization rotating reflector disposed facing the third side surface,
wherein the reflective polarizers, the polarization rotating reflectors, the retarder, and the broadband mirrors cooperate so that a path length of the input light beam from the first input surface to the second output surface within the optical integrator is at least about seven times a length of the first PBS measured normal to the input surface.

12. An optical integrator, comprising:
a first and a second polarizing beam splitter (PBS), each PBS comprising:
an input surface disposed to receive an input light beam normal to the input surface, an output surface adjacent the input surface, and two side surfaces;
a reflective polarizer aligned to a first polarization direction and disposed within the PBS to intercept the input light beam at an angle of approximately 45 degrees;
a retarder disposed immediately adjacent the reflective polarizer and opposite the input surface, the retarder aligned at an angle of approximately 45 degrees to the first polarization direction; and
a first and a second broadband mirror disposed facing each of the two side surfaces;
wherein the output surface of the first PBS is facing the input surface of the second PBS, and further
wherein the reflective polarizers, the retarders, and the broadband mirrors cooperate so that a path length of the input light beam from the input surface to the output surface within the optical integrator is at least about six times a length of the PBS measured normal to the input surface.

13. An optical integrator, comprising:
a first and a second polarizing beam splitter (PBS), each PBS comprising:
an input surface disposed to receive an input light beam normal to the input surface, a first output surface, a second output surface opposite the input surface, and a side surface;
a reflective polarizer aligned to a first polarization direction and disposed within the PBS to intercept the input light beam at an angle of approximately 45 degrees;
a first polarization rotating reflector disposed facing the side surface, wherein the first output surface of the first PBS faces the first output surface of the second PBS; and
a half-wave retarder disposed between the first output surface of the first PBS and the first output surface of the second PBS,
wherein the reflective polarizers, the polarization rotating reflectors, and the half-wave retarder cooperate so that a path length of the input light beam from the input surface of the first PBS to the second output surface of the second PBS within the optical integrator is at least about three times a length of the first PBS measured normal to the input surface.

14-20. (canceled)
